(19) United States
(12) Patent Application Publication
(10) Pub. No.: US 2018/0000229 A1
(43) Pub. Date: Jan. 4, 2018

(54) RUBBER STAMP HAVING FOLDABLE HANDLE

(71) Applicant: Brian Lott, Gilmer, TX (US)

(72) Inventor: Brian Lott, Gilmer, TX (US)

(21) Appl. No.: 15/490,636

(22) Filed: Apr. 18, 2017

Related U.S. Application Data
(60) Provisional application No. 62/324,166, filed on Apr. 18, 2016.

(51) Int. Cl. A45D 40/30; A01M 31/02

(52) U.S. Cl. CPC A45D 40/30; A01M 31/025

(57) ABSTRACT

A rubber camouflage stamp that includes: a convertible stamp apparatus and a locking lid. The convertible stamp apparatus preferably includes a substantially planar body that includes a stamp side opposite a handle side. The stamp side defines a contoured rubber surface that has a camouflage pattern carved, molded, laser engraved or vulcanized therein. Preferably, the stamp side may be deployed in the same manner as conventional rubber stamp to receive an ink coating and transfer the ink coated thereon to a medium by pressing the stamp side against the medium. The stamp side may be used to transfer ink to a user's face.

### BACKGROUND OF THE INVENTION

### Field of the Invention

The present invention relates to portable stamping apparatus and, more particularly, to a rubber camouflage stamp having a foldable handle for use in outdoors environments.

### Description of the Prior Art

When hunting or otherwise in outdoor environments, it is common for individuals to paint camouflage style patterns on their face in order to help conceal themselves in the environment. A problem which still exists, however, is that creating realistic patterns without smudging the paint can be very difficult and time consuming in such an outdoor environment. Thus, there remains a need for a rubber camouflage stamp having a fold out handle which can be used to quickly apply paint to ones face in any environment. It would be helpful if such a rubber camouflage stamp included a securing lid which was biased to only open when the handle is moved to a deployed position. It would be additionally desirable for such a rubber camouflage stamp to include a preset camouflage texture on its stamp side to ensure a proper application of paint each time it is used.

The Applicant's invention described herein provides for a rubber camouflage stamp adapted to allow a user to covert it from a flat storage position in which its stamp side is securely covered to a deployed position in which its stamp side may be exposed. The primary components in Applicant's rubber camouflage stamp are a convertible stamp apparatus and a locking lid. When in operation, the rubber camouflage stamp enables more effective and efficient application of face paint in an outdoor setting. As a result, many of the limitations imposed by prior art structures are removed.

### SUMMARY OF THE INVENTION

A rubber camouflage stamp that includes: a convertible stamp apparatus and a locking lid. The convertible stamp apparatus preferably includes a substantially planar body that includes a stamp side opposite a handle side. The stamp side defines a contoured rubber surface that has a camouflage pattern carved, molded, laser engraved or vulcanized therein. Preferably, the stamp side may be deployed in the same manner as conventional rubber stamp to receive an ink coating and transfer the ink coated thereon to a medium by pressing the stamp side against the medium. The stamp side may be used to transfer ink to a user's face.

### BRIEF DESCRIPTION OF THE DRAWINGS

FIG. 1 is front elevational view of a convertible stamp apparatus of a rubber camouflage stamp built in accordance with the present invention.

FIG. 2 is rear elevational view of a convertible stamp apparatus of a rubber camouflage stamp built in accordance with the present invention shown with the handle in the storage position.

FIG. 3 is an exploded side elevational view of cross section of a rubber camouflage stamp built in accordance with the present invention shown with the handle in the deployed position.

FIG. 4 is a rear elevational view of a locking lid of a rubber camouflage stamp built in accordance with the present invention.

### DETAILED DESCRIPTION OF THE INVENTION

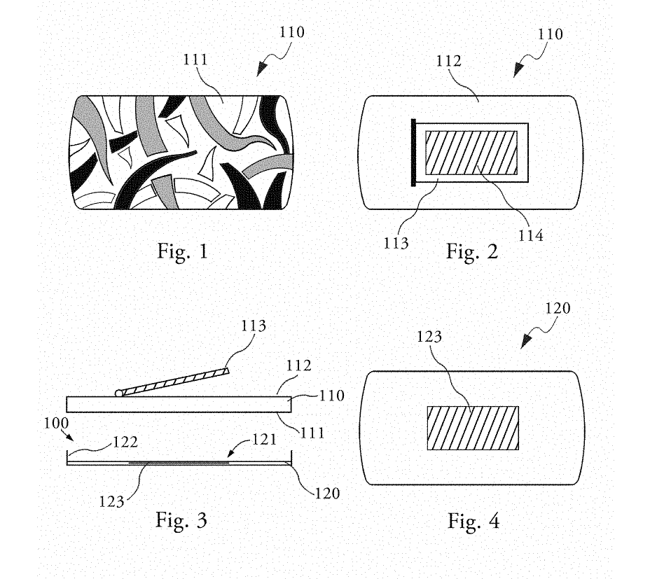

Referring now to the drawings and in particular FIGS. 1, 2, 3, and 4, a rubber camouflage stamp 100 is shown as a convertible stamp apparatus 110 and a locking lid 120. The convertible stamp apparatus 110 has a substantially planar body that includes a stamp side 111 opposite a handle side 112. The stamp side 111 defines a contoured rubber surface that has a camouflage pattern carved, molded, laser engraved or vulcanized therein. In this regard, the stamp side 111 may be deployed in the same manner as conventional rubber stamp to receive an ink coating and transfer the ink coated thereon to a medium by pressing the stamp side 111 against the medium. It is contemplated that in accordance with the present that the stamp side 111 is employed to transfer ink to a user's face.

The handle side 112 includes a hinged handle member 113 which is operative to swing between a storage position in which it lies flat against the handle side 112 and a deployed position in which it is lifted off the handle side 112. The deployed position is exemplified in FIG. 3. In one embodiment, the handle member 113 includes a permanent magnet 114 integrated therein. The permanent magnet 114 operates to bias the handle member 113 into the storage position when the locking lid 120 is in place on the convertible stamp apparatus 110 in the manner described below.

The locking lid 120 is defined by an interior tray 121 that is surrounded by an elevated perimeter wall 122 which extends around its edge. In this regard, the locking lid 120 is sized to receive the stamp side 111 so that its walls 122 operate to enclose the stamp side 111.

In one embodiment, the locking lid 120 includes a ferromagnetic member 123 integrated therewith in a central position which corresponds to the positioning of the permanent magnet 114 in the convertible stamp apparatus 110. In this regard, when the convertible stamp apparatus 110 is in place in the locking lid 120 with its stamp side 111 against the interior tray 121, the permanent magnet 114 exerts a magnetic force on the ferromagnetic member 123 which operates to compress the convertible stamp apparatus 110 against the locking lid 120, thereby biasing the convertible stamp apparatus 110 and locking lid 120 together to resist inadvertently falling apart. Only through the purposeful manual application of separating pressure on the convertible stamp apparatus 110 and locking lid 120 with the two components be separated. In one embodiment, a user may lift the handle member 113 before separating the convertible stamp apparatus 110 and locking lid 120 to reduce the pull of the magnetic field of the permanent magnet 114.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A rubber camouflage stamp comprising:
a. a convertible stamp apparatus, wherein the stamp apparatus includes a planar body with a stamp side and a handle side; and
b. a locking lid.

2. The rubber camouflage stamp according to claim 1, where the stamp side defines a contoured rubber surface that has a camouflage pattern.

3. The rubber camouflage stamp according to claim 2, where the camouflage pattern is carved, molded, laser engraved or vulcanized therein.

4. The rubber camouflage stamp according to claim 1, wherein the handle side includes a hinged handle member which is operative to swing between a storage position in which it lies flat against the handle side and a deployed position in which it is lifted off the handle side.

5. The rubber camouflage stamp according to claim 4, the hinged handle member includes a permanent magnet integrated therein, where permanent magnet operates to bias the handle member into the storage position when the locking lid is in place.

6. The rubber camouflage stamp according to claim 1, where the locking lid is defined by an interior tray that is surrounded by an elevated perimeter wall, which extends around its edge.

7. The rubber camouflage stamp according to claim 1, where the locking lid includes a ferromagnetic member integrated therewith in a central position which corresponds to the positioning of a permanent magnet in the convertible stamp apparatus.
